(19) United States
(12) Patent Application Publication
(10) Pub. No.: US 2004/0196824 A1
(43) Pub. Date: Oct. 7, 2004

(54) Device for synchronization of a mobile radio receiver to a frame structure of a received radio signal

(76) Inventor: Thuyen Le, Munchen (DE)

Correspondence Address: Andreas Grubert, Baker Botts L.L.P., One Shall Plaza, 910 Louisiana, Houston, TX, 77002-4495, US

(21) Appl. No.: 10/800,495

(22) Filed: Mar. 15, 2004

(30) Foreign Application Priority Data
Mar. 14, 2003 (DE) 103 11 323.1

(51) Int. Cl. H04J 3/06; H04L 12/43

(52) U.S. Cl. 370/350

(57) ABSTRACT

A device (1) for accelerated synchronization of a mobile radio receiver to a frame structure of a received radio signal, comprises a unit (2) to determine energy values that were received by the mobile radio receiver for each frame synchronization code per time slot, at least two intermediate memories (TEMP_RAM_EVEN, TEMP_RAM_ODD) to store the energy values and a unit (PEAK_DETECT, 3) to calculate the frame start of the radio signal from the energy values and the known frame synchronization codes.

This application claims priority to German application no. 103 11 323.1 filed Mar. 14, 2003.

### TECHNICAL FIELD OF INVENTION

The invention relates to a device for a mobile radio receiver, by means of which the mobile radio receiver is synchronized to the frame structure of a radio signal transmitted by a base station and received by the mobile radio receiver.

According to the UMTS (universal mobile telecommunications system) standard, data are transferred between the base station and the mobile radio receiver in a frame structure. Each frame in the UMTS standard contains 15 time slots, each of which has 2560 chips.

Time synchronicity between the base station and mobile radio receiver is necessary for operation of a mobile radio system. The synchronization of the mobile radio receiver required for this is accomplished, among other things, during switching-on of the mobile radio receiver, during transfer into a new cell or on request from higher logging levels. A distinction is made between time slot and frame synchronization. The purpose of time slot synchronization is to find the time slot boundaries. If the time slot boundaries are found, frame synchronization can be conducted. The beginning of a frame is then sought.

Synchronization codes, each consisting of a sequence of chips, are available for time slot and frame synchronization. The synchronization codes are sent by the base station at the beginning of each time slot and are available in the mobile radio receiver. The synchronization codes received by the mobile radio receiver are correlated with the known synchronization codes. The time slot and frame limits are determined from the correlation results.

While the time slot synchronization code used for time slot synchronization also carries the name “primary synchronization code” (PSC), the frame synchronization codes used for frame synchronization are also called “secondary synchronization codes” (SSC).

Synchronization of a mobile radio receiver to the frame structure of a radio signal sent by a base station is treated below.

In the UMTS standard, there are 16 different frame synchronization codes C_{SSCa} (a=1, 2, . . . , 16), each of which consists of 256 chips. Each frame synchronization code C_{SSCa} is generated by position multiplication of a generating Hadamard sequence, with a sequence z common to all frame synchronization codes C_{SSCa}. Sequence z is constructed a follows, in which ⊕ represents the Kronecker product:

$$\begin{matrix}z = [ b , b , b , - b , b , b , - b , - b , b , - b , b , - b , - b , - b , - b , - b ] \\ = [ 1 , 1 , 1 , - 1 , 1 , 1 , - 1 , - 1 , 1 , - 1 , 1 , - 1 , - 1 , - 1 , - 1 , - 1 ] ⊗ b\end{matrix} \qquad ( 1 )$$

According to equation (1), the sequence z consists of 16 sequence elements. Each sequence element is based on a sequence b, which is multiplied either by +1 or by −1. Sequence b is complex-valued and is generated from a sequence of 16 chips, each of which can assume either the value +1 or the value −1:

b=(1+j) [1,1,1,1,1,1,−1,−1,−1,1,−1,1,−1,1,1,−1] (2)

If equations (1) and (2) are combined, it is apparent that sequence z has a total of 256 chips.

Position multiplication of sequence z by 16 different Hadamard sequences, which also have a length of 256 chips, yields the 16 different frame synchronization codes C_{SSCa}.

At the beginning of each time slot, a specific frame synchronization code C_{SSCa} is sent by the base station. The series sequence of the transmitted frame synchronization code C_{SSCa} is the same in each frame at a given base station. The possible sequences, in which the frame synchronization code C_{SSCa} can be sent within one frame are stipulated by so-called code groups CG(m) (m=0, 1, . . . , 63):

CG(m)=[C_{m,0}, C_{m,1}, . . . , C_{m,14}] (3)

The elements C_{m,k} of the code group CG(m) are taken from the set of frame synchronization codes C_{SSCa}:

Cm,k ε{CSSC1, CSSC2, . . . , CSSC16} (4)

The index k (k=0, 1, . . . 14) states the consecutive number of the 15 time slots.

Overall, there are 64 code groups CG(m). The code groups CG(m) are constructed so that each cyclic shift of element C_{m,k} of a code group CG(m) occurs only once within the set of code groups CG(m). This means that a cyclic shift of element C_{m′,k} of a code group CG(m′) by more than 0 and less than 15 places is not identical to a cyclic shift the elements C_{m″,k} of another code group CG(m″). This also means that no cyclic shift of elements C_{m,k} within a code group CG(m) by more than 0 and less than 15 places is identical to another cyclic shift within the same code group CG(m).

The 64 code groups CG(m) are listed in FIG. 1 in the table. The code groups CG(m) are also found in the UMTS specification “Spreading and modulation (FDD)”, 3^{rd} Generation Partnership Project TS 25.213 V4.3.0 (2002-06), and specifically in section 5.2.3.2 and there in Table 4. The entries in the table of FIG. 1 give the index a of the frame synchronization codes C_{SSCa} , which is to be sent at the beginning of a specific time slot k for a specific code group CG(m). For example, the entry “7”, which is found in the table under the time slot #4 and code group CG(1), denotes the frame synchronization code C_{SSC7}. Below, reference is made to the table from FIG. 1 as a 64×15-Matrix CG(m, k) (m=0, 1, . . . , 63; k=0, 1 . . . ,14).

Time slot synchronization is ordinarily completed during execution of frame synchronization, so that the time slot boundaries are known. The 256 chips of the frame synchronization code being entered in the mobile radio receiver at the beginning of a time slot could therefore be detected and used to determine the frame limits.

Beginning from the start index of each time slot, 256 scanning values are initially multiplied by the complex-value sequence z position-wise. From the 16 consecutive multiplication results, a sum is then formed. This corresponds to a correlation of the scanning values with sequence b, which underlies sequence z. In this case, the sign, with which the sequence b is burdened as a function of its position in sequence z, is also already considered. Overall, 16 complex-value correlation values X(i) (i=0, 1, . . . , 15) are obtained for each time slot. The correlation values X(i) are summarized in a column vector X:

X=[X(0), X(0), . . . , X(15)]T (5)

Only the sequence z has thus far been included in the correlation value X(i). For a complete frame synchronization, the Hadamard sequences, with which sequence z was multiplied to generate the frame synchronization code C_{SSCa}, must still be considered. This occurs in the context of a Hadamard transformation. For this purpose, vector X is multiplied by a 16×16 Hadamard matrix H₁₆, and a column vector Y is obtained as a result, having 16 components Y(i) (i=0, 1, . . . , 15).

$$[ \begin{matrix}Y ( 0 ) \\ Y ( 1 ) \\ M \\ Y ( 15 )\end{matrix} ] = {H}_{16} \cdot [ \begin{matrix}X ( 0 ) \\ X ( 1 ) \\ M \\ X ( 15 )\end{matrix} ] \qquad ( 6 )$$

The Hadamard matrix H₁₆ exclusively contains the elements +1 and −1. The 16 components Y(i) of vector Y give the energies with which the 16 frame synchronization codes C_{SSCa} were received in the corresponding time slot of the mobile radio receiver.

According to the designation of vector Y, it is written in a column of a 16×15-Matrix A(i, j) (i=0, 1, . . . , 15;j=0, 1, . . . , 14). Each of the 15 columns of the matrix A(i, j) is reserved for a specific time slot of a frame. Vector Y, obtained from the first investigated time slot, is therefore written in column j=0, and the vector Y from the subsequent time slot is written in the column j=1. The subsequent procedure continues accordingly.

The procedure just described means that the elements of matrix A(i,j) give the received energies for the 16 frame synchronization codes C_{SSCa} within the time length of a frame.

The search for the frame boundary is equivalent to checking, by means of matrix A(i,j), which code group CG(m) were sent by the base station. Knowledge of this code group CG(m) leads directly to the frame boundary.

To determine the code group CG(m) sent by the base station, the received energy is calculated for each of the code groups CG(m) listed in the table of FIG. 1. All possible cyclic shifts in the corresponding group CG(m) must then be considered. Overall, this procedure means that all possible transmission sequences of frame synchronization codes C_{SSCa} are considered.

The received energy Dval(m,n), which is obtained from a specific code group CG(m) and a specific shift within the code group CG(m) by n places, is calculated according to the following equation:

$$Dval ( m , n ) = {\sum }_{k = 0}^{14} A ( CG ( m , k ) , ( k - n ) mod15 ) \qquad ( 7 )$$

According to this equation, all energy values Dval(m,n) for all indices m (m=0, 1, . . . , 63) and n (n=0, 1, . . . 14), the maximum energy value Dval(mₘₐₓ,nₘₐₓ) can be determined:

Dval(mmax,nmax)=max(Dval(m,n)) (8)

The maximum energy value Dval(mₘₐₓ,nₘₐₓ) includes two important pieces of information. In the first place, index mₘₐₓ gives the code group CG(mₘₐₓ) that was sent by the base station with the highest probability. In the second place, the frame begins in the time slot designated by the index nₘₐₓ.

Storage or the energy values Dval(m,n) is generally not necessary, since determination of the maximum energy value Dval(mₘₐₓ,nₘₐₓ) is conducted iteratively and “on the fly”.

In working out the algorithm just described, the matrix A(ij) is generally calculated by hardware components, because of the high calculation demand. The calculated elements of matrix A(i,j) are sent to a digital signal processor that determines the maximum energy value Dval(mₘₐₓ,nₘₐₓ) by means of equations (7) and (8).

The latency time for determination of the code group sent by a base station is determined by the number of memory accesses necessary, in order to read matrix A(i, j) from the memory of the digital signal processor. With 64 code groups, 15 possible cyclic shifts and 15 time slots per frame, 64×15×15=14400 time cycles are required for this purpose.

### SUMMARY OF THE INVENTION

The task of the invention is to devise an apparatus for synchronization of a mobile radio receiver to a frame structure of a received radio signal, in which the apparatus is supposed to carry out frame synchronization in a much shorter time than previous devices that serve the same purpose.

An unloading of the digital signal processor of the mobile radio receiver is also supposed to be achieved by the invention.

The task underlying the invention can be achieved by a device for synchronization of a mobile radio receiver to a frame structure from a radio signal received from a base station, wherein a frame is divided into a stipulated number N of time slots, and the base station, per frame, sends a sequence of known frame synchronization codes known in the mobile radio receiver, comprising a first unit to determine the energy values that are received for N consecutive time slots for each frame synchronization code per time slot by the mobile radio receiver, at least two intermediate memories to store the received energy values, and a second unit to calculate the frame start of the radio signal from the energy values stored in the at least two intermediate memories and as a function of the known frame synchronization code.

Each sequence of frame synchronization codes that can be sent by the base station in a frame may form a code group, and the code groups can be stored in at least two code group memories that are read-only memories. The second unit can also be laid out to calculate the code group sent by the base station from the energy values stored in the at least two intermediate memories and as a function of the known code groups. An address generation unit can be connected after the at least two code group memories, which generates addresses from the elements of the code group released from the at least two code group memories, the addresses can each be fed to one of the at least two intermediate memories, and the at least two intermediate memories can issue an energy value stored in it, which is designated by the address supplied to the corresponding intermediate memory. The device may comprise a first control unit to control the control output of elements of code groups from the at least two code group memories. The device may comprise a second control unit to control generation of the addresses in the address generation units. The device may comprise a third control element to control supply of addresses to the at least two intermediate memories. The device may comprise an adder connected after the at least two intermediate memories, which sums up the energy values released by the at least two intermediate memories, in which at least one of the summands, if necessary, is replaced by the energy value zero. The device may comprise a fourth control unit to control supply of summands to the adder. The device may comprise an accumulator connected after adder, which sums up a stipulated number of energy values released in succession by the adder. The device may comprise a third unit connected after the accumulator to determine the largest energy value issued by the accumulator. The device may comprise a fourth unit connected after the third unit to calculate the frame start of the radio signal sent by the base station and the code group sent by the base station. The energy values entered in the at least two intermediate memories may correspond to the time slot in which the frame synchronization codes underlying them were received and can be marked with an index j, and the received energy values are entered as a function of their index j in the at least two intermediate memories. Each of the received energy values can be entered in precisely one of the at least two intermediate memories, and at least one energy value can additionally be entered in another of the at least two intermediate memories. The elements of the code groups corresponding to the time slot to which they refer can be marked with the index n, and each element of code groups can be entered as a function of their index n in precisely one of the at least two code group memories, and the number of code group memories can be equal to the number of intermediate memories. The elements of code groups with an even index n can be entered in a first code group memory and the element of the code group with an odd index n can be entered in a second code group memory. The first unit can be laid out so that the energy values are calculated by means of correlations of the received frame synchronization codes with a common sequence underlying the known frame synchronization codes and a subsequent Hadamard transformation. Data transmission between the base station and the mobile radio receiver can be based on the UMTS standard.

The device according to the invention is used for synchronization of a mobile radio receiver to a frame structure of a radio signal received from a base station. The base state sends, per frame, a sequence of frame synchronization codes to the mobile receiver that are also present in the mobile radio receiver. A frame is then divided into a stipulated number N of time slots.

The device according to the invention contains a first unit to determine the energy values, at least two random-access intermediate memories and a second unit to calculate the frame start of the radio signal.

The energy values determined by the first unit are the energies that are received by the mobile radio receiver per time slot for each frame synchronization code. The energy values are then determined for N consecutive time slots and entered in the at least two intermediate memories. From the second unit, the frame start of the radio signal is calculated from the energy values entered in the at least two intermediate memories and as a fiction of the known frame synchronization codes.

Since the at least two intermediate memories can be accessed simultaneously, the energy values entered there can be sent to further processing with a high rate of the second unit. As a result, this leads to a significantly shortened latency time during the synchronization process relative to the prior art.

The device according to the invention can also be present as a hard-wired circuit. A digital signal processor contained in the mobile radio receiver is therefore relieved of the calculations conducted by the device according to the invention.

It can be prescribed that each sequence of frame synchronization codes that must be sent by the base station in one frame forms a code group. The code groups are preferably entered into at least two code group memories contained in the device according to the invention. Since the code groups are established from the outset, the at least two code group memories can be designed as read-only memories. By using at least two code group memories, the elements of the code groups can be made available for further processing particularly quickly.

The second unit also advantageously serves to calculate the code groups sent by the base station. To perform this calculation, the energy values stored in the at least two intermediate memories and the known code groups are used. With reference to the determined code group, the base station sending the radio signal can be identified.

A preferred embodiment of the invention proposes that an address generation unit be connected after the at least two code group memories. The address generation units generate addresses by mean of elements of the code groups issued from the at least two code group memories. Each address is fed to one of the at least two intermediate memories. The at least two intermediate memories then give an energy value stored in them, which is designated by the address fed to the corresponding intermediate memory.

According to another preferred embodiment of the invention, the device contains a first and/or a second and/or a third control unit.

Whereas the first control unit serves to control output of the elements of the code groups from the at least two code group memories, the second control unit controls generation of the addresses in the address generation units. The task of the third control unit is to control supply of addresses to the at least two intermediate memories.

Another proposed embodiment of the invention is characterized by the fact that an adder is connected after the at least two intermediate memories, which adds the energy values issued by the at least two intermediate memories. If required, at least one of the summands of the aforementioned sum can be replaced by the energy value zero.

Supply of the summands to the adder is preferably controlled by a fourth control unit.

An accumulator connected advantageously after the adder can be used to sum up a stipulated number of energy values issued in succession by the adder.

The energy values summed up by the accumulator, for example, gives the energy received by the mobile radio receiver for a specific code group during the length of one frame. It is worthwhile for subsequent processing to determine, among the accumulated energy values, the maximum energy value. This task preferably is assigned to a third unit connected after the accumulator.

A fourth unit can then advantageously calculate the frame start of the radio signal sent by the base station and the code group sent by the base station by means of the maximum energy value.

A particularly preferred embodiment of the invention proposes that the energy values stored in the at least two intermediate memories be marked with an index j according to the time slot in which the underlying frame synchronization codes are received. This makes it possible to enter the received energy values in the at least two intermediate memories as a fiction of their index j.

It can preferably be prescribed that each of the received energy values be entered in precisely one of the at least two intermediate memories. In order to avoid, under some circumstances, doubtful access during a time cycle to only one intermediate memory, it can also be prescribed that at least one energy value, which is marked by the specified index j, is also entered in an additional intermediate memory.

The elements of the code groups can also be marked with an index n corresponding to the time slot to which they refer. Because of this, the elements of the code groups can also be arranged as a function of their index n in the at least two code group memories. Each element of the code groups is preferably entered in precisely one of the at least two code group memories. The device then has just as many code group memories as intermediate memories.

It can preferably be prescribed that the elements of the code groups with even indices n be entered in a first code group memory, and the elements of the code groups with odd indices n be entered in a second code group memory.

Another particularly preferred embodiment of the invention proposes that the first unit calculates the energy values by correlating the received frame synchronization codes with a common sequence underlying the known frame synchronization codes and transforming the correlation results by means of a Hadamard transformation.

Data transmission between the base station and the mobile radio receiver is preferably based on the UNTS standard.

### BRIEF DESCRIPTION OF THE DRAWINGS

The invention is further explained below as an example with reference to the drawings. In the drawings:

FIG. 1 shows a depiction of the code group CG(m) in a table;

FIG. 2 shows a schematic circuit diagram with a practical example of the device according to the invention;

FIG. 3A shows the arrangement of elements of matrix CG(m,n) in the memories CG_ROM_EVEN and CG₁₃ ROM_ODD;

FIG. 3B shows the arrangement of elements of matrix A(i, j) in the memories TEMP_RAM_EVEN and TEMP_RAM_ODD; and

FIG. 4 shows the variables j1 and j2 as a function of the indices n and k in a table.

### DETAILED DESCRIPTION OF THE EMBODIMENTS

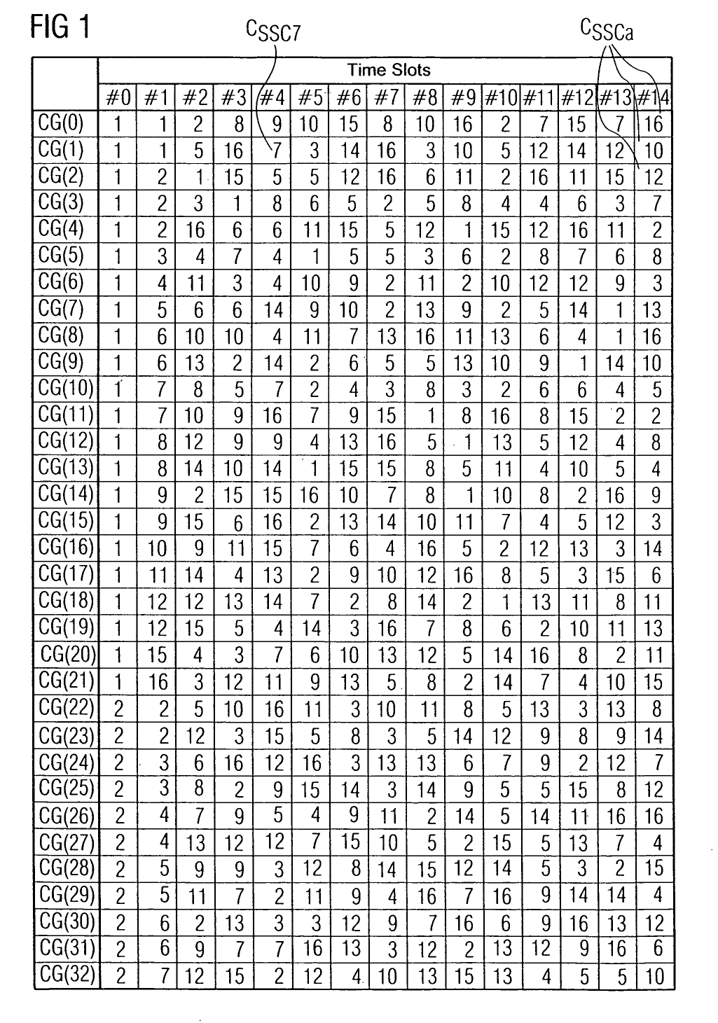

FIG. 1 schematically depicts the circuit diagram of a device 1 as a practical example of the device according to the invention. The device 1 is implemented in a mobile radio receiver and laid out to determine the beginning of a frame of a received radio signal that was sent by a base station.

The device 1 has memories CG_ROM_EVEN, CG_ROM_ODD, TEMP_RAM_EVEN and TEMP_RAM_ODD. The device 1 also contains address generation units CG_ADDR_CALC, AMAT_ADDR_CALC, ADDR_MAP1 and ADDR_MAP2, control units CONTROL_MUX_1/2, CONTROL_MUX_3 and CONTROL_MUX_4, 2:1-Multiplexer MUX_1, MUX_2, MUX_3 and MUX_4, an adder ADD, an accumulator ACCU, a unit PEAK_DETECT, a unit 2 and a unit 3.

The address generation unit CG_ADDR_CALC is connected with control inputs of memory CG_ROM_EVEN and CG_ROM_ODD. The output of memory CG_ROM_EVEN is connected to the input of the address generation unit ADDR_MAP_1. An input of the address generation unit ADDR_MAP_2 is connected behind the output of the memory CG_ROM_EVEN. An input of the address generation unit ADDR_MAP_2 is connected behind the output of the memory CG_ROM_ODD. Another input of the address generation units ADDR_MAP_1 and ADDR_MAP_2 are connected to the outputs of the address generation unit AMAT_ADDR_CALC.

The 2:1-Multiplexers MUX_1 and MUX_2 are connected after the address generation units ADDR_MAP_1 and ADDR_MAP_2. The multiplexers MUX_1 and MUX_2 are controlled by the control unit CONTROL_MUX_1/2.

The memories TEMP_RAM_EVEN and the 2:1-Multiplexer MUX_3 are arranged in series behind the 2:1-Multiplexer MUX_1. The memory TEMP_RAM_ODD and the 2:1-Multiplexer MUX_4 are connected in series after the 2:1-Multiplexer MUX_2. Unit 2 supplies both the memory TEMP_RAM_EVEN and the memory TEMP_RAM_ODD. One output each of the 2:1-Multiplexers MUX_3 and MUX_4 is set at zero. The 2:1-Multiplexer MUX_3 is controlled by the control unit CONTROL_MUX_3. The 2:1-Multiplexer MUX_4 receives control signals from the control unit CONTROL_MUX_4.

The outputs of the 2:1-Multiplexer MUX_3 and MUX_4 supply the adder ADD, behind which the accumulator ACCU, the unit PEAK-DETECT and the unit 3 are arranged in the stated sequence.

The following equation (9) gives the algorithm, by means of which the energy Dval(m,n) received by the mobile radio receiver, and which has its origin in the sending of a code group CG(m) with a cyclic shift by n places by the base station, is calculated:

$$\begin{matrix}Dval ( m , n ) = {\sum }_{k = 0}^{6} [ A ( i1 ( m , k ) , j1 ( n , k ) ) + \\ A ( i2 ( m , k ) , j2 ( n , k ) ) ] + \\ A ( i1 ( m , k = 7 ) , j1 ( n , k = 7 ) )\end{matrix} \qquad ( 9 )$$

In equation (9), the index m (m=0, 1, . . . , 63) denotes the code group CG(m), as listed in the table of FIG. 1, and the index n (n=0, 1, . . . , 14) gives the number of shifts, by which the frame synchronization codes C_{SSCa} are cyclically shifted in the corresponding code group CG(m). The index k (k=0, 1, . . . , 7) is the summation index.

The variables i1, i2, j1 and j2 occurring in equation (9) are calculated by the following equations (10) to (13):

i1(m,k)=CG(m,2k) (10)

i2(m,k)=CG(m,2k+1) (11)

j1(n,k)=(2k−n)mod15 (12)

j2(n,k)=(2k+1−n)mod15 (13)

Equations (10) to (13) are chosen so that the equations (7) and (9) do not differ in result. However, equations (7) and (9) differ in the number of time cycles required for their calculation. Whereas 15 time cycles are necessary for calculation for equation (7), equation (9) can be calculated in 8 time cycles.

For calculation of equation (9), the elements of the matrices CG(m,n) and A(i,j) must be available. The elements of matrix CG(m,n) are established from the outset and are entered in memories CG_ROM_EVEN and CG_ROM_ODD. The elements of matrix A(ij) must be calculated according to the above equation (6) and the text following it. This occurs in unit 2. The elements of matrix A(i,j) are then temporarily stored in memories TEMP_RAM_EVEN and TEMP_RAM_ODD.

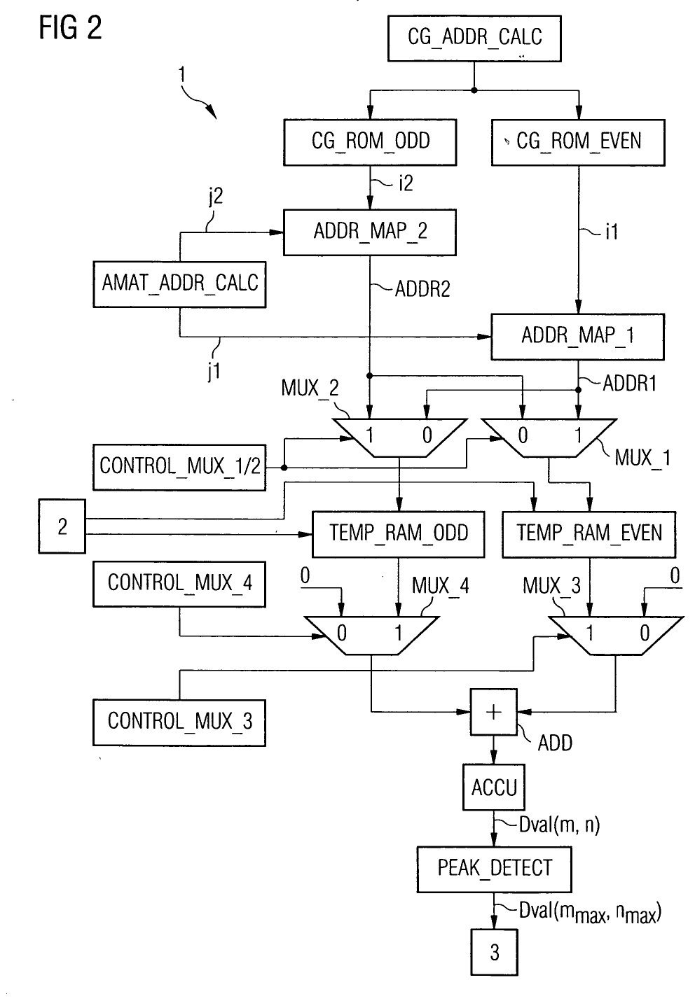

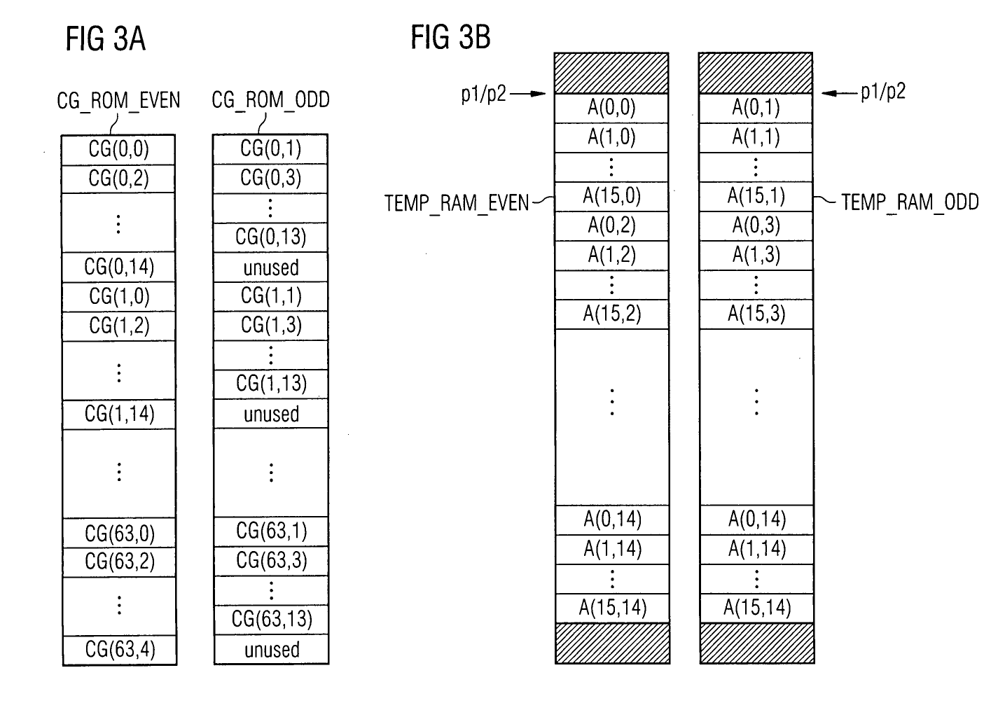

The arrangement of the elements of matrices CG(m,n) and A(i,j) in the memories CG_ROM_EVEN, CG_ROM_ODD, TEMP_RAM_EVEN and TEMP_RAM_ODD is shown in FIGS. 3A and 3B and described below.

Whereas the elements of matrix CG(m,n) with even n are stored in the memory CG_ROM_EVEN, the elements of matrix CG(m,n) with odd n are stored in the memory CG_ROM_ODD. Since the matrix CG(m,n) is established from the outset, the memories CG_ROM_EVEN and CG_ROM_ODD can be laid out as read-only memories.

All elements of matrix A(i,j) with even j are temporarily stored in the memory TEMP_RAM_EVEN. The elements of matrix A(i,j) that have odd j are entered in memory TEMP—RAM_ODD. The elements of matrix A(i,j) with j=14 are also not only temporarily stored in memory TEMP_RAM_EVEN, but also the memory TEMP_RAM_ODD. Since the matrix A(ij) must be calculated again before each pass of the device 1, the memories TEMP_RAM_EVEN and TEMP_RAM_ODD must be laid out as random-access memories.

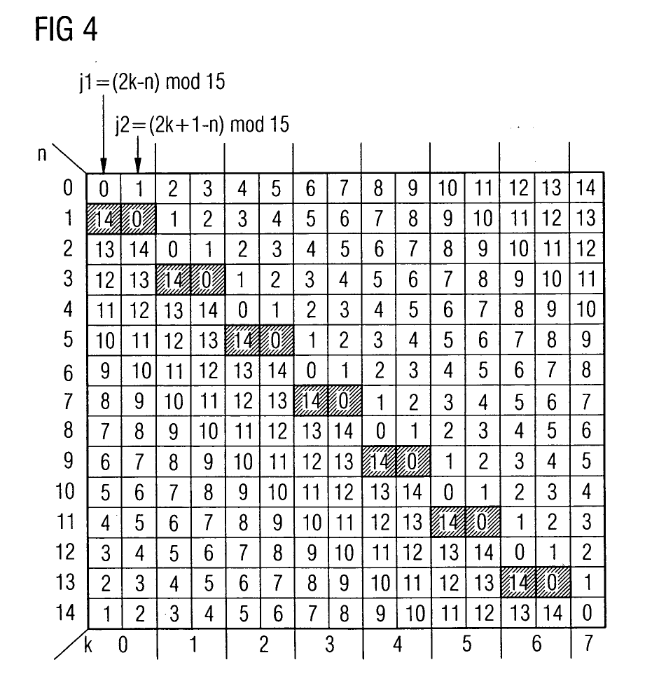

The elements of matrix A(i,j) are arranged in the memories TEMP_RAM_EVEN and TEMP_RAM_ODD, so that two elements from the same memory TEMP_RAM_EVEN or TEMP_RAM_ODD need never be read from the same memory for the same index k. This case could occur for j =14, if the elements of matrix A(i,j) were only divided according to even and odd j to the memories TEMP_RAM-EVEN and TEMP_RAM_ODD. In FIG. 4, the results of equations (12) and (13) for the variables j1 and j2 are plotted as a function of indices n and k. If the matrix elements A(ij)=14 were not also entered in memory TEMP_RAM_ODD, in the cases underscored in gray in FIG. 4, the memory TEMP_RAM_EVEN would have to be accessed twice during one time cycle.

It should also be noted that the memories CG_ROM_EVEN and CG_ROM_ODD are laid out as physically independent memories. This makes it possible to simultaneously access both memories CG_ROM_EVEN and CG_ROM_ODD during one time cycle. The same also applies for the memories TEMP_RAM_EVEN and TEMP_RAM_ODD.

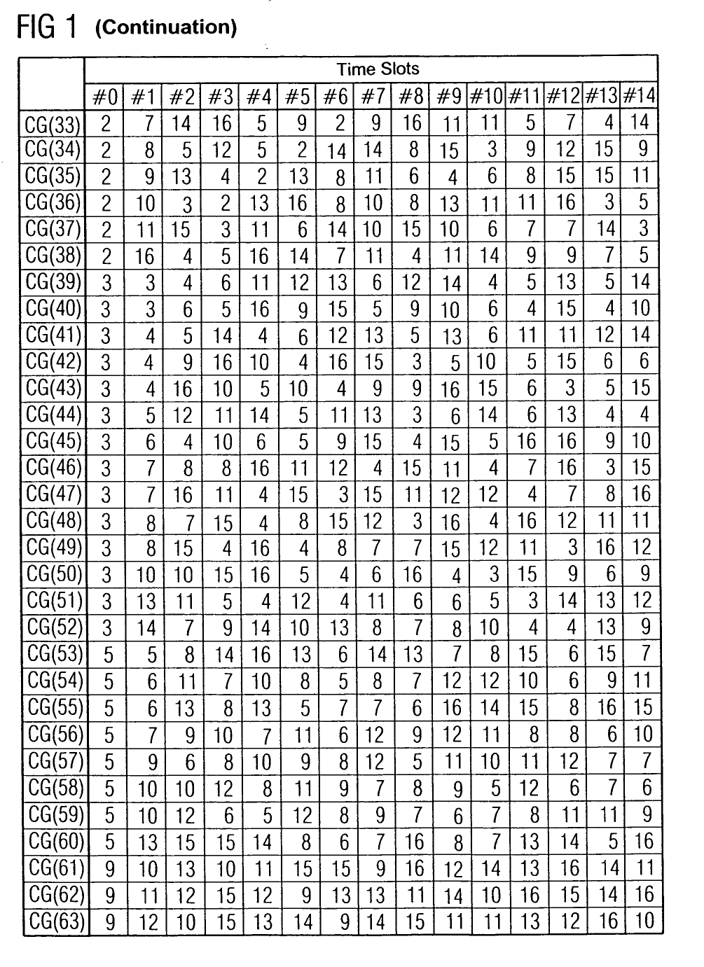

To calculate equation (9), the indices m, n and k must be passed through. This is accomplished in device by means of counters, which are not shown in FIG. 2.

The address generation unit CG_ADDR_CALC calculates, by means of indices m and k and with equations (10) and (11), the addresses under which the variables i1 and i2 are entered in the memories CG_ROM_EVEN and CG_ROM_ODD. The variable i1 can therefore be read out from memory CG_ROM_EVEN and the variable i2 from memory CG_ROM_ODD.

The address generation unit AMAT_ADDR_CALC calculates the variables j1 and j2 according to equations (12) and (13) by means of indices n and k.

The variables i1 and j1 are fed to the address generation unit ADDR_MAP_1, which calculates an address ADDR1 from it. Under the address ADDR1, the matrix element A(i1,j1) can be found in the memory TEMP_RAM_EVEN or in the memory TEMP_RAM_ODD. Since not only the elements of matrix A(i,j) need be entered in memories TEMP_RAM_EVEN and TEMP_RAM_ODD, the address ADDR1 includes a pointer p1 that indicates, in the memory TEMP_RAM_EVEN or the memory TEMP-RAM_ODD, the beginning of the data block that contains the elements of matrix A(i,j). With consideration of the arrangement of matrix elements A(ij) depicted in FIG. 3B in the memories TEMP_RAM_EVEN and TEMP_RAM_ODD, we obtain for the address ADDR1:

ADDR1=i1+(j1/2)*16+p1 (14)

Correspondingly, for calculation of the address ADDR1, and address ADDR2 is calculated by the address generation unit ADDR_MAP_2 from the variables i2 and j2 supplied to it, under which the matrix element A(i2,j2) can be found in the memory TEMP_RAM_EVEN or in the memory TEMP_RAM_ADD. The address ADDR2 also includes a pointer 2, which indicates, in memory TEMP_RAM_EVEN or in memory TEMP_RAM_ODD, the beginning of the data block that contains the elements of matrix A(ij). For the address ADDR2, we get:

ADDR2=i2+(j2/2)*16+p2 (15)

The addresses ADDR1 and ADDR2 contain no information on whether the corresponding matrix elements A(i1,j1) and A(i2,j2) are entered in the memory TEMP_RAM_EVEN or in the memory TEMP_RAM_ODD. The memory locations are calculated by the control unit CONTROL_MUX_1/2, which controls the 2:1-Multiplexers MUX_1 and MUX_2 by means of this information. The 2:1-Multiplexers MUX_1 and MUX_2 are connected, so that the addresses ADDR1 and ADDR2 are supplied to the memory TEMP_RAM_EVEN or TEMP_RAM_ODD, in which the matrix element A(i1,j1) or A(i2,j2) are entered.

The control unit CONTROL_MUX_1/2 uses the following described algorithm to determine the necessary switching position of the 2:1-Multiplexers MUX_1 and MUX_2.

Initially, it is investigated whether the variable j1 is even and whether it is not equal to 14. Depending on the results of this query, three cases are distinguished. It must be kept in mind that these cases are only relevant when index k assumes a value smaller than 7.

1. If variable j1 is even and not equal to 14, variable j2 is odd. In this case, the control unit CONTROL_MUX_1/2 switches the 2:1-Multiplexers MUX_1 and MUX_2 to the switch position 1, so that the address ADDR1 is fed to memory TEMP_RAM_EVEN and the address ADDR2 is conveyed to the memory TEMP_RAM_ODD.

2. If the variable j1 equals 14, the variable j2 equals zero. In this case, by means of control unit CONTROL_MUX_1/2, the logic paths zero of the 2:1-Multiplexers MUX_1 and MUX_2 are switched. This means that the address ADDR1 is fed to memory TEMP_RAM_ODD and the address ADDR2 is sent to memory TEMP_RAM_EVEN.

3. If the variable j1 is odd and therefore not equal to 14, variable j2 is even. In this case, the control unit CONTROL_MUX_1/2 switches the multiplexers MUX_1 and MUX_2, as in the preceding case, to the switch position 0.

In addition, the still omitted case must be considered, in which k=1. In this case, only the matrix element A(i1,j1) is valid, since for k=7, no matrix element (i2,j2) exists. This is because a frame 15 has time slots and the time slots are considered in pairs. Consequently, only one matrix element can be given for k=7. To determine the control signal that is generated by the control unit CONTROL_MUX_1/2, it must be checked for the case k=7 whether j1 is even. Two cases are therefore considered.

1. If j1 is even, the control unit CONTROL_MUX_1/2 switches the 2:1-Multiplexer MUX_1 to switch position 1, so that the address ADDR1 is fed to memory TEMP_RAM_EVEN.

2. If j1 is odd, the control unit CONTROL_MUX_1/2 switches the 2:-Multiplexer MUX_1 to the circuit switch position 0, so that the address ADDR1 is fed to memory TEMP_RAM_ODD.

The matrix elements A(i1,j1) and A(i2,j2), determined by the addresses ADDR1 and ADDR2, are released at the outputs of memories TEMP_RAM_EVEN and TEMP_RAM_ODD.

For the case when index k assumes a value smaller than 7, the matrix elements A(i1,j1) and A(i2,j2) are conveyed to the adder ADD. For this purpose, the logic paths 1 of the 2:1-Multiplexers MUX_3 and MUX_4 must be switched by the control units CONTROL_MUX_3 and CONTROL_MUX_4.

For the case where k=7, it must be checked whether j1 is odd. If this is so, the control unit CONTROL_MUX_1 supplies the control signal 0 to the 2:1-Multiplexer MUX_3 and the control unit CONTROL_MUX_4 supplies the control signal 1 to the 2:1-Multiplexer MUX_4. Otherwise, the control input of the 2:1-Multiplexer MUX_1 is exposed to the control signal 1 and the control input of the 2:1-Multiplexer MUX_4 with the control signal 0. This switching of the multiplexers MUX_3 and MUX_4 guarantees that in the case k=7, only the memory TEMP_RAM_EVEN or TEMP_RAM_ODD is connected to the adder ADD, in which the matrix element A(i1,j1) is situated. The other input of the adder ADD, in this case, is set with a zero.

The adder ADD sums the matrix elements A(i1,j1) and A(i2,j2) or zero, fed to it simultaneously in pairs. The resulting addition results area accumulated by the accumulator ACCU over 8 time cycles. This corresponds in equation (9) to summation over index k. Consequently, the accumulator ACCU gives the energy value Dval(m,n) according to equation (9).

In a further step, the maximum energy value Dval(mₘₐₓ,nₘₐₓ) is determined:

Dval(mmax,nmax)=max(Dval(m,n)) (16)

For this purpose, the unit PEAK_DETECT compares each new entering energy value Dval(m,n) with the previously determined maximum energy value Dval(mₘₐₓ,nₘₐₓ) and, if necessary replaces the previously determined maximum energy value Dval(mₘₐₓ,nₘₐₓ) with the newly entered energy value Dval(m,n). For initialization in this first run of the device 1, the maximum energy value Dval(mₘₐₓ,nₘₐₓ) is set at zero.

After 64×15=960 energy values Dval(m,n) have been calculated, the maximum energy value derived from it Dval(mₘₐₓ,nₘₐₓ) is transferred by the unit PEAK_DETECT to unit 3. Unit 3 determines from this maximum energy value Dval(mₘₐₓ,nₘₐₓ) the indices mₘₐₓ and nₘₐₓ, which give the group CG(mₘₐₓ) received by the mobile radio receiver and the frame boundary nₘₐₓ of the received radio signal. Both values can be used for further processing steps by a digital signal processor that can be arranged in unit 3.

Device 1 requires, for determination of the code group sent by the base station and for determination of the frame boundary of the radio signal, a latency time of 64×15×8=7680 time cycles. This corresponds to a reduction in the latency time according to the prior art by almost half.

A further reduction of latency time is also possible. For this purpose, the number of memories, in which the elements of matrix A(i,j) are temporarily stored would have to be increased from two to, say, four or eight. The factor, by which the latency time relative to the prior art, would be reduced would then correspond to roughly the number of these memories.

If additional such memories for temporary storage of the matrix elements A(i,j) are added to device 1, in addition to the memories TEMP_RAM_EVEN and TEMP_RAM_ODD depicted in FIG. 2, the arrangement and circuitry of these components connected in front of the memories must be modified accordingly. For example, in this case, it is worthwhile to connect the additional memories according to the wiring of the memories TEMP_RAM_EVEN and TEMP_RAM_ODD, also memories, in which the elements of the matrix CG(m,n) are entered, and address generation units.

I claim:

1. A device for synchronization of a mobile radio receiver to a frame structure from a radio signal received from a base station, wherein a frame is divided into a stipulated number N of time slots, and the base station, per frame, sends a sequence of known frame synchronization codes known in the mobile radio receiver, comprising:
a first unit to determine the energy values that are received for N consecutive time slots for each frame synchronization code per time slot by the mobile radio receiver,
at least two intermediate memories to store the received energy values, and
a second unit to calculate the frame start of the radio signal from the energy values stored in the at least two intermediate memories and as a function of the known frame synchronization code.

2. The device according to claim 1, wherein
each sequence of frame synchronization codes that can be sent by the base station in a frame forms a code group, and
the code groups are stored in at least two code group memories that are read-only memories.

3. The device according to claim 2, wherein
the second unit is also laid out to calculate the code group sent by the base station from the energy values stored in the at least two intermediate memories and as a function of the known code groups.

4. The device according to claim 2, wherein
an address generation unit is connected after the at least two code group memories, which generates addresses from the elements of the code group released from the at least two code group memories,
the addresses are each fed to one of the at least two intermediate memories, and
the at least two intermediate memories issue an energy value stored in it, which is
designated by the address supplied to the corresponding intermediate memory.

5. The device according to claim 4, comprising
a first control unit to control the control output of elements of code groups from the at least two code group memories.

6. The device according to claim 4, comprising
a second control unit to control generation of the addresses in the address generation units.

7. The device according to claim 4, comprising
a third control element to control supply of addresses to the at least two intermediate memories.

8. The device according to claim 4, comprising
an adder connected after the at least two intermediate memories, which sums up the energy values released by the at least two intermediate memories, in which at least one of the summands, if necessary, is replaced by the energy value zero.

9. The device according to claim 8, comprising
a fourth control unit to control supply of summands to the adder.

10. The device according to claim 8, comprising
an accumulator connected after adder, which sums up a stipulated number of energy values released in succession by the adder.

11. The device according to claim 10, comprising
a third unit connected after the accumulator to determine the largest energy value issued by the accumulator.

12. The device according to claim 11, comprising
a fourth unit connected after the third unit to calculate the frame start of the radio signal sent by the base station and the code group sent by the base station.

13. The device according to claim 1, wherein
the energy values entered in the at least two intermediate memories correspond to the time slot in which the frame synchronization codes underlying them were received and are marked with an index j, and
the received energy values are entered as a function of their index j in the at least two intermediate memories.

14. The device according to claim 13, wherein
each of the received energy values is entered in precisely one of the at least two intermediate memories, and
at least one energy value is additionally entered in another of the at least two intermediate memories.

15. The device according to claim 2, wherein
the elements of the code groups corresponding to the time slot to which they refer are marked with the index n, and
each element of code groups are entered as a function of their index n in precisely one of the at least two code group memories, and
the number of code group memories is equal to the number of intermediate memories.

16. The device according to claim 15, wherein
the elements of code groups with an even index n are entered in a first code group memory and the element of the code group with an odd index n are entered in a second code group memory.

17. The device according to claim 1, wherein
the first unit is laid out so that the energy values are calculated by means of correlations of the received frame synchronization codes with a common sequence underlying the known frame synchronization codes and a subsequent Hadamard transformation.

18. The device according to claim 1, wherein
data transmission between the base station and the mobile radio receiver is based on the UMTS standard.
